(19) United States
(12) Patent Application Publication
(10) Pub. No.: US 2006/0236549 A1
(43) Pub. Date: Oct. 26, 2006

(54) Folding knife with cam actuated opening and closing assistance

(76) Inventor: Peter J. Martin, Waterford, WI (US)

Correspondence Address: Donald J. Ersler, 725 Garvens Avenue, Brookfield, WI, 53005, US

(21) Appl. No.: 11/113,623

(22) Filed: Apr. 25, 2005

(51) Int. Cl. B26B 1/02

(52) U.S. Cl. 30/161

(57) ABSTRACT

A folding knife with cam actuated opening and closing assistance preferably includes a pivoting blade, a biasing spacer, a front liner and a rear liner. A cam surface is formed on one end of the pivoting blade and a cutting edge is formed along at least one side of the pivoting blade. The cam surface preferably starts with a radius that gradually increases into a larger radius. One end of the pivoting blade is pivotally retained by at least one of the liners. Substantially one end of the biasing spacer is retained between the first and second liners and substantially the other end exerts force on the cam surface. The shape of the cam surface is designed to rotate the pivot blade relative to the liners, when force is applied through the biasing spacer. The biasing portion assists the opening and closing of the pivoting blade.

### BACKGROUND OF THE INVENTION

1. Field of the Invention

The present invention relates generally to folding knifes and more specifically to a folding knife with cam actuated opening and closing assistance, which has fewer parts than that of the prior art.

2. Discussion of the Prior Art

U.S. Pat. No. 6,397,476 to Onion discloses an opening and closing mechanism for a folding knife. The Onion patent includes a mechanism in a folding knife that urges the blade to move to an open and alternatively to a closed position. However, the Onion patent includes numerous elements. U.S. Pat. No. 6,308,420 to Moser discloses a folding knife with spring and cam. The Moser patent includes an elongated blade having a working end and a tang at the opposite end within a common plane, a pivot including a pivot axis connecting the tang to the handle to permit the blade to pivot selectively into an open position at which the blade extends outwardly from the handle and into a closed position in which the blade is nested into the spacing. However, the Moser patent includes numerous elements.

Accordingly, there is a clearly felt need in the art for a folding knife with cam actuated opening and closing assistance, which is less costly to manufacture, because thereof has fewer parts than that of the prior art.

### SUMMARY OF THE INVENTION

The present invention provides a folding knife with cam actuated opening and closing assistance, which as fewer parts than that of the prior art. The folding knife with cam actuated opening and closing assistance (folding cam knife) preferably includes a pivoting blade, a biasing spacer, a front liner, a rear liner, a front handle and a rear handle. A cam surface is formed on one end of the pivoting blade and a cutting edge is formed along at least one side of the pivoting blade. The cam surface starts with a small radius that gradually increases into a larger radius. A spring flat is formed adjacent the cam surface and a support flat is formed adjacent the spring flat. A thumb stud extends from the pivoting blade opposite the cutting edge.

A pivot pin is retained by at least one of the liners. A pivot hole is formed through the one end of the pivoting blade and is sized to receive the pivot pin. A stop pin extends from at least one of the liners on one side of the pivot pin. The stop pin contacts the support flat on the pivoting blade. A lock bar is formed on the other side of the pivot pin. The lock bar engages a lock notch formed in a back side of the pivoting blade at the one end. The rear handle is attached to the rear liner. The front liner is attached to the rear liner through the biasing spacer. The front handle is attached to the front liner.

When the pivoting blade is in a fully open position, the stop pin and lock bar prevent the pivoting blade from pivoting. The biasing spacer includes a retention portion and a biasing portion. The retention portion is retained by at least one of the liners at substantially the other end thereof. The biasing portion is normally biased toward the pivot pin. The biasing portion contacts the cam surface. The shape of the cam surface is designed to rotate the pivot blade to relative to the liners, when force is applied through the biasing portion. The biasing portion assists the opening and closing of the pivoting blade.

Accordingly, it is an object of the present invention to provide a folding cam knife, which is less costly to manufacture, because thereof has fewer parts than that of the prior art.

These and additional objects, advantages, features and benefits of the present invention will become apparent from the following specification.

### BRIEF DESCRIPTION OF THE DRAWINGS

FIG. 1 is an exploded perspective view of a folding cam knife in accordance with the present invention.

FIG. 2 is a side view of a folding cam knife in an open position with a front liner removed in accordance with the present invention.

FIG. 3 is a side view of a folding cam knife in a closed position with a front liner removed in accordance with the present invention.

FIG. 4 is a partially exploded top view of a folding cam knife in an open position in accordance with the present invention.

FIG. 5 is a partially exploded bottom view of a folding cam knife in an open position in accordance with the present invention.

FIG. 6 is a partially exploded bottom view of a folding cam knife in a closed position in accordance with the present invention.

FIG. 7 is an enlarged side view of a pivot area of a folding cam knife in an open position with a front liner removed in accordance with the present invention.

FIG. 8 is an enlarged side view of a pivot area of a folding cam knife in a closed position with a front liner removed in accordance with the present invention.

### DETAILED DESCRIPTION OF THE PREFERRED EMBODIMENTS

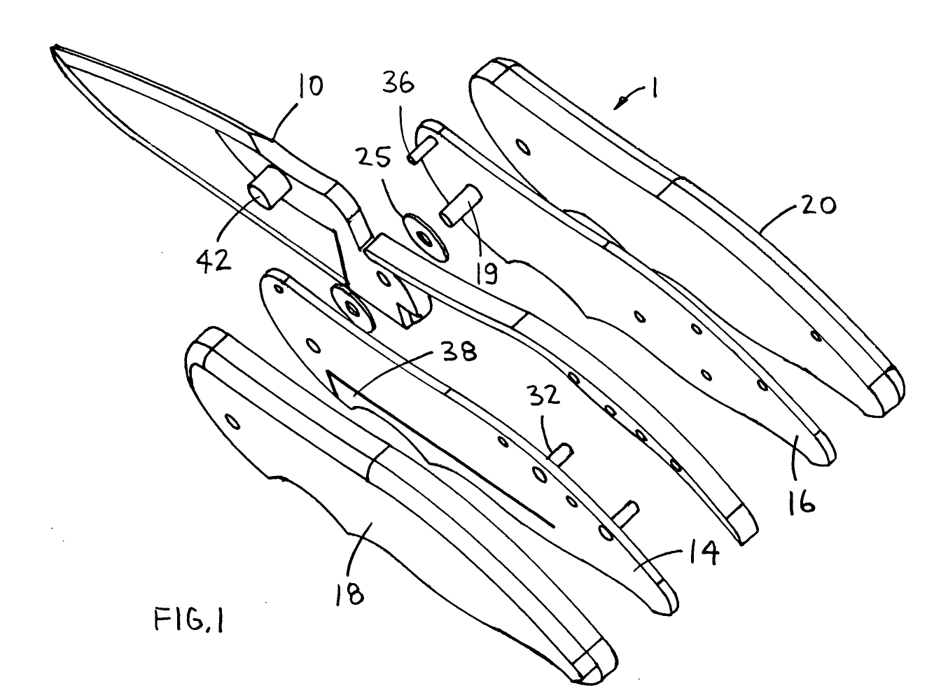

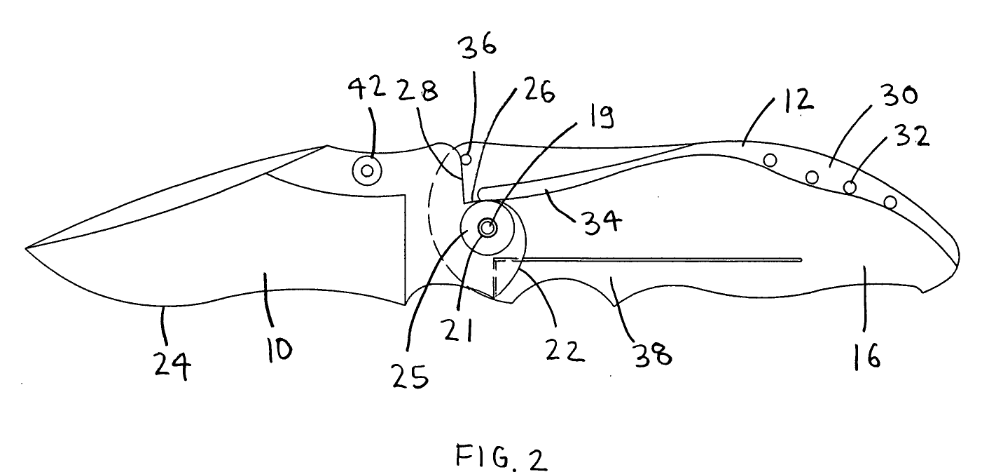

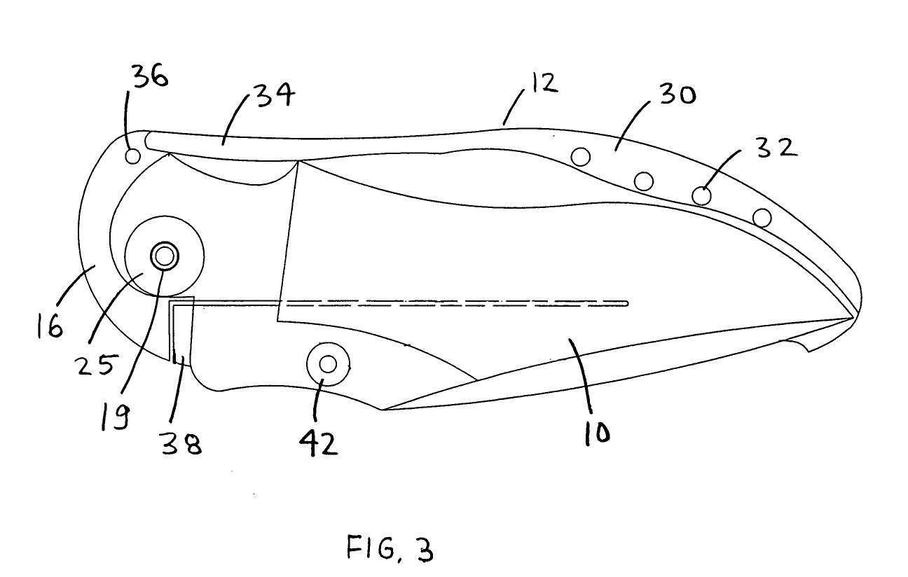

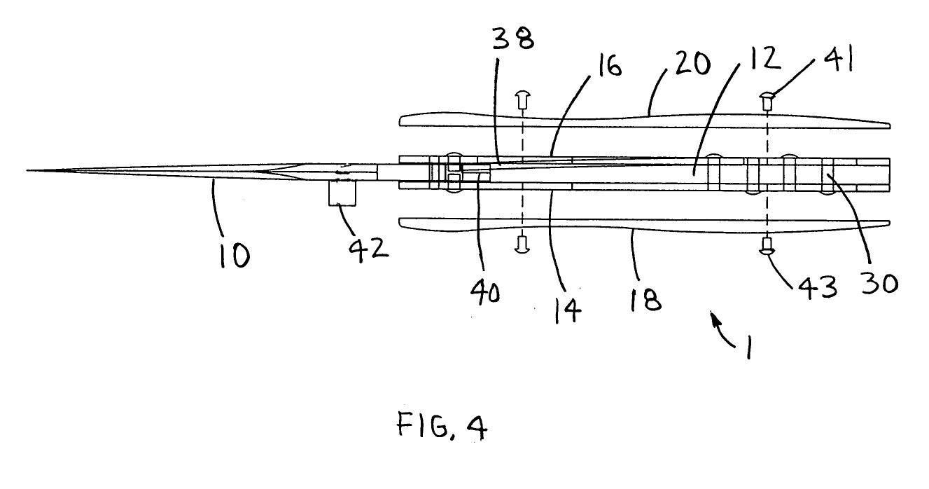

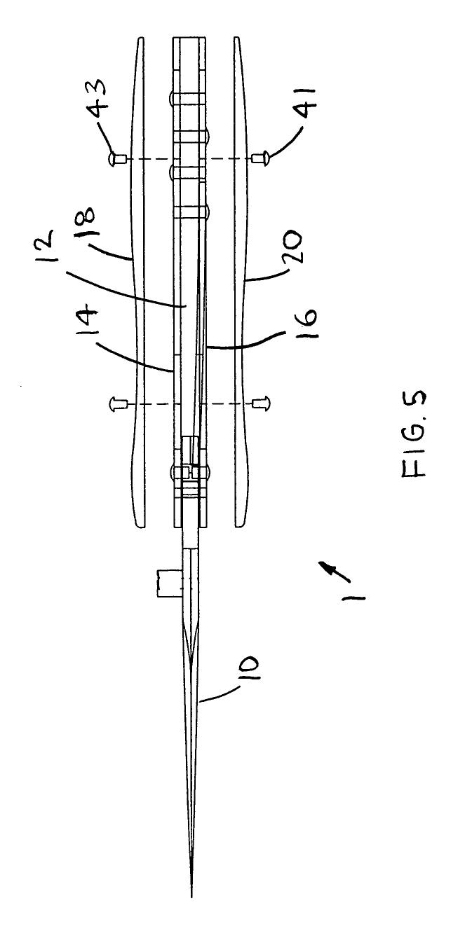

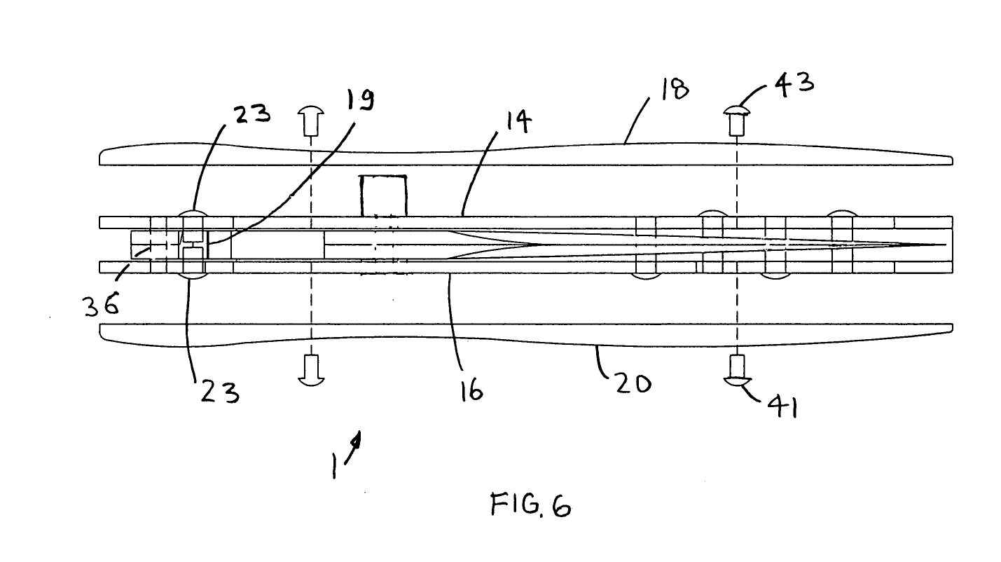

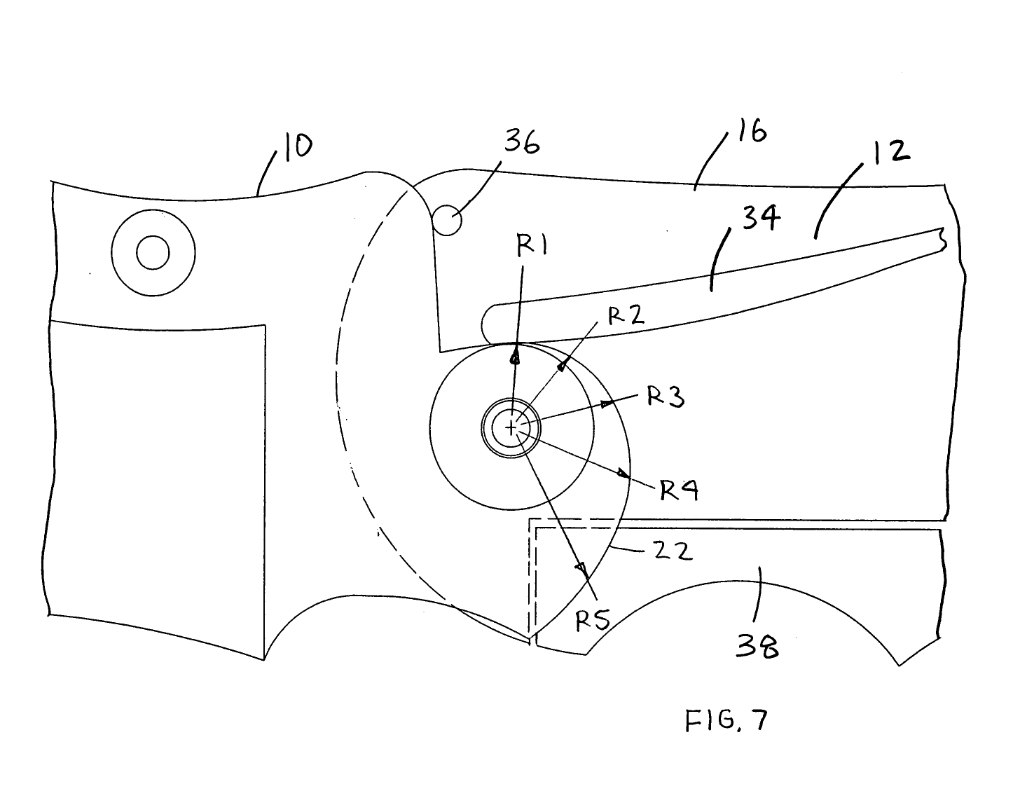

With reference now to the drawings, and particularly to FIG. 1, there is shown an exploded perspective view of a folding cam knife 1. With reference to FIGS. 2-6, the folding cam knife 1 includes a pivoting blade 10, a biasing spacer 12, a front liner 14, a rear liner 16, a front handle 18 and a rear handle 20. A pivot pin 19 is retained by at least one of the liners with at least one fastener 23 or any other appropriate device. The pivot pin 19 is received by a pivot hole 21 formed through the one end of the pivoting blade 10. A cam surface 22 is formed on the one end of the pivoting blade 10 and a cutting edge 24 is formed along at least one side of the pivoting blade 10. With reference to FIG. 7, the cam surface 22 preferably starts with a contour having a radius R1 that gradually increases into a larger radius R5. Where, R5>R4>R3>R2>R1. However, other cam contours may also be used. A blade spacer 25 is preferably inserted between the front liner 14 and one side of the pivoting blade 10, and between the rear liner 16 and other side of the pivoting blade 10.

A spring flat 26 is formed adjacent the cam surface 22 and a support flat 28 is formed adjacent the spring flat 26. The biasing spacer 12 includes a retention portion 30 formed on substantially one end and a biasing portion 34 formed on substantially the other end thereof. The biasing spacer 12 is secured to at least one of the liners with pins 32 or any other suitable device. The biasing spacer 12 provides clearance between the front and rear liners for the pivoting blade 10. The biasing portion 34 is biased in the direction of the pivot pin 19. The biasing portion 34 exerts force against the spring flat 26, when the pivoting blade 10 is in an open position. The biasing portion 34 also exerts force against the cam surface 22, when the biasing portion 34 is in contact therewith. The biasing spacer 12 does not have to act as a spacer, but could merely be a biasing device. The biasing device would be retained by at least one of the liners.

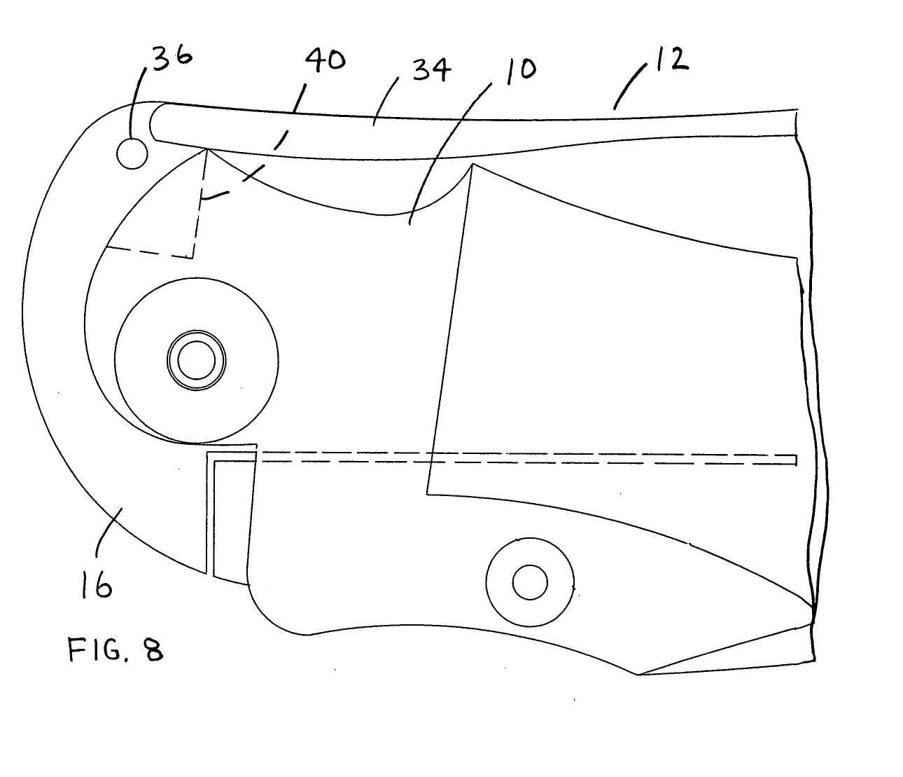

A stop pin 36 is retained by at least one of the liners on one side of the pivot pin 19. The stop pin 36 engages the support flat 28, when the pivoting blade 10 is in an open position. A lock bar 38 is cut from the rear liner 16 on the other side of the pivot pin 19. With reference to FIG. 8, the lock bar 38 engages a lock notch 40 formed in a back side of the pivoting blade 10 at the one end. When the pivoting blade 10 is in a fully open position, the stop pin 36 and lock bar 40 prevent the pivoting blade 10 from pivoting.

The rear handle 20 is attached to a back of the rear liner 16 with fasteners 41. The front handle 18 is attached to the front liner 14 with fasteners 43. A thumb stud 42 extends from the pivoting blade 10 opposite the cutting edge 24. The thumb stud 42 is used to start the rotation of the pivoting blade 10 from the closed position to the open position, and from the open position to the closed position. The shape of the cam surface 22 is designed to assist rotation of the pivoting blade 10 relative to the liners and handles, when force is applied through the biasing portion 34.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of providing a folding knife having cam actuated opening and closing assistance, comprising the steps of:
connecting pivotally one end of a blade to one end of at least one liner;
forming a cam surface on said one end of said blade; and
applying force to said cam surface, said blade being assisted during opening by application of force to said cam surface.

2. The method of providing a folding knife having cam actuated opening and closing assistance of claim 1, further comprising the step of:
providing said cam surface with a contour having a radius that increases into a larger radius.

3. The method of providing a folding knife having cam actuated opening and closing assistance of claim 1, further comprising the step of:
providing a biasing spacer having a retention portion and a biasing portion, attaching said retention portion to said at least one liner, said biasing portion applying force to said cam surface.

4. The method of providing a folding knife having cam actuated opening and closing assistance of claim 3, further comprising the step of:
providing a front liner and a rear liner for said at least one liner, pivotally retaining said blade between said front and rear liners, retaining said biasing spacer between said front and rear liners.

5. The method of providing a folding knife having cam actuated opening and closing assistance of claim 3, further comprising the step of:
forming a spring flat adjacent said cam surface, said spring flat receiving force from said biasing spacer when said blade is in an open position.

6. The method of providing a folding knife having cam actuated opening and closing assistance of claim 5, further comprising the step of:
forming a stop flat adjacent said spring flat, forming a lock notch in said one end of said blade, inserting a stop pin in said one end of said at least one liner, forming a lock bar in one of said at least one liner, said stop pin engaging said stop flat and said lock bar engaging said lock notch to retain said blade in the open position.

7. The method of providing a folding knife having cam actuated opening and closing assistance of claim 1, further comprising the step of:
forming a cutting edge along at least one side of said blade.

8. A method of providing a folding knife having cam actuated opening and closing assistance, comprising the steps of:
connecting pivotally one end of a blade to one end of at least one liner;
forming a cam surface on said one end of said blade, said cam surface having a contour having a radius that increases into a larger radius; and
applying force to said cam surface, said blade being assisted during opening by application of force to said cam surface.

9. The method of providing a folding knife having cam actuated opening and closing assistance of claim 8, further comprising the step of:
providing a biasing spacer having a retention portion and a biasing portion, attaching said retention portion to said at least one liner, said biasing portion applying force to said cam surface.

10. The method of providing a folding knife having cam actuated opening and closing assistance of claim 8, further comprising the step of:
providing a front liner and a rear liner for said at least one liner, pivotally retaining said blade between said front and rear liners, retaining said biasing spacer between said front and rear liners.

11. The method of providing a folding knife having cam actuated opening and closing assistance of claim 8, further comprising the step of:
forming a spring flat adjacent said cam surface, said spring flat receiving force from said biasing spacer when said blade is in an open position.

12. The method of providing a folding knife having cam actuated opening and closing assistance of claim 11, further comprising the step of:
forming a stop flat adjacent said spring flat, forming a lock notch in said one end of said blade, inserting a stop pin in said one end of said at least one liner, forming a lock bar in one of said at least one liner, said stop pin engaging said stop flat and said lock bar engaging said lock notch to retain said blade in an open position.

13. The method of providing a folding knife having cam actuated opening and closing assistance of claim 8, further comprising the step of:
forming a cutting edge along at least one side of said blade.

14. A method of providing a folding knife having cam actuated opening and closing assistance, comprising the steps of:
connecting pivotally one end of a blade to one end of at least one liner;
forming a cam surface on said one end of said blade;
securing one end of a biasing device to said at least one liner, the other end of said biasing device applying force to said cam surface; and
said blade being assisted during opening by application of force to said cam surface.

15. The method of providing a folding knife having cam actuated opening and closing assistance of claim 14, further comprising the step of:
providing said cam surface with a contour having a radius that increases into a larger radius.

16. The method of providing a folding knife having cam actuated opening and closing assistance of claim 14, further comprising the step of:
providing a front liner and a rear liner for said at least one liner, pivotally retaining said blade between said front and rear liners, retaining said biasing spacer between said front and rear liners.

17. The method of providing a folding knife having cam actuated opening and closing assistance of claim 14, further comprising the step of:
forming a spring flat adjacent said cam surface, said spring flat receiving force from said biasing device when said blade is in an open position.

18. The method of providing a folding knife having cam actuated opening and closing assistance of claim 17, further comprising the step of:
forming a stop flat adjacent said spring flat, forming a lock notch in said one end of said blade, inserting a stop pin in said one end of said at least one liner, forming a lock bar in one of said at least one liner, said stop pin engaging said stop flat and said lock bar engaging said lock notch to retain said blade in an open position.

19. The method of providing a folding knife having cam actuated opening and closing assistance of claim 14, further comprising the step of:
forming a cutting edge along at least one side of said blade.

20. The method of providing a folding knife having cam actuated opening and closing assistance of claim 16, further comprising the step of:
securing a front handle to an outside surface of said front liner and securing a rear handle to an outside surface of said rear liner.
